(19) United States
(12) Patent Application Publication
(10) Pub. No.: US 2018/0267923 A1
(43) Pub. Date: Sep. 20, 2018

(54) TRANSFER CONTROL DEVICE, PROCESSING SYSTEM, AND PROCESSING DEVICE

(71) Applicant: FUJI XEROX CO., LTD., Tokyo (JP)

(72) Inventors: Masaki NUDEJIMA, Kanagawa (JP); Tomoyuki ONO, Kanagawa (JP); Takayuki HASHIMOTO, Kanagawa (JP); Suguru OUE, Kanagawa (JP)

(73) Assignee: FUJI XEROX CO., LTD., Tokyo (JP)

(21) Appl. No.: 15/709,968

(22) Filed: Sep. 20, 2017

(30) Foreign Application Priority Data
Mar. 17, 2017 (JP) 2017-053066

(51) Int. Cl. G06F 13/42; G06F 13/16; G06F 3/06

(52) U.S. Cl. CPC G06F 13/42; G06F 13/1668; G06F 3/0604; G06F 3/0673; G06F 3/0629; G06F 3/0655; G06F 3/061

(57) ABSTRACT

A transfer control device includes: a write issuing unit that, after issuing to a transfer path a first write request for writing a last portion of data of a processing unit to a memory, issues a second write request for writing confirmation information to an area different from an area of the memory to which the data is written, the transfer path maintaining an order of write requests and an order of read requests and not maintaining an order between the write requests and the read requests; and a read issuing unit that issues to the transfer path a first read request for reading the confirmation information, after the second write request is issued, and issues to the transfer path a second read request for the data of the processing unit written to the memory, after reading the confirmation information in response to the first read request.

### CROSS-REFERENCE TO RELATED APPLICATIONS

This application is based on and claims priority under 35 USC 119 from Japanese Patent Application No. 2017-053066 filed Mar. 17, 2017.

### BACKGROUND

### (i) Technical Field

The present invention relates to a transfer control device, a processing system, and a processing device.

### (ii) Related Art

As one type of data transfer path, there is a transfer path that maintains the order of read requests and the order of write requests, but does not maintain the order between the read requests and the write requests. Examples of such transfer paths include a transfer path that conforms to the Advanced eXtensible Interface (AXI) protocol.

### SUMMARY

According to an aspect of the invention, there is provided a transfer control device including: a write issuing unit that, after issuing to a transfer path a first write request for writing a last portion of data of a processing unit to a memory, issues a second write request for writing confirmation information to an area different from an area of the memory to which the data is written, the transfer path maintaining an order of write requests and an order of read requests and not maintaining an order between the write requests and the read requests; and a read issuing unit that issues to the transfer path a first read request for reading the confirmation information, after the second write request is issued, and issues to the transfer path a second read request for the data of the processing unit written to the memory, after reading the confirmation information in response to the first read request.

### BRIEF DESCRIPTION OF THE DRAWINGS

An exemplary embodiment of the present invention will be described in detail based on the following figures, wherein:

FIG. 1 illustrates an example of a system to which a mechanism of an exemplary embodiment is applied;

FIG. 2 illustrates an example of an internal configuration of an image processing unit;

FIG. 3 illustrates a problem which may occur in image processing using a line buffer;

FIG. 4 illustrates providing a flag area in a shared memory, separately from a line buffer;

FIG. 5 illustrates an example of a procedure of processing performed by a DMAC;

FIG. 6 illustrates an example of a procedure performed by a processing device according to a modification; and

FIG. 7 illustrates an example of a procedure performed by a processing device according to another modification.

### DETAILED DESCRIPTION

Hereinafter, an exemplary embodiment of the present invention will be described with reference to the accompanying drawings.

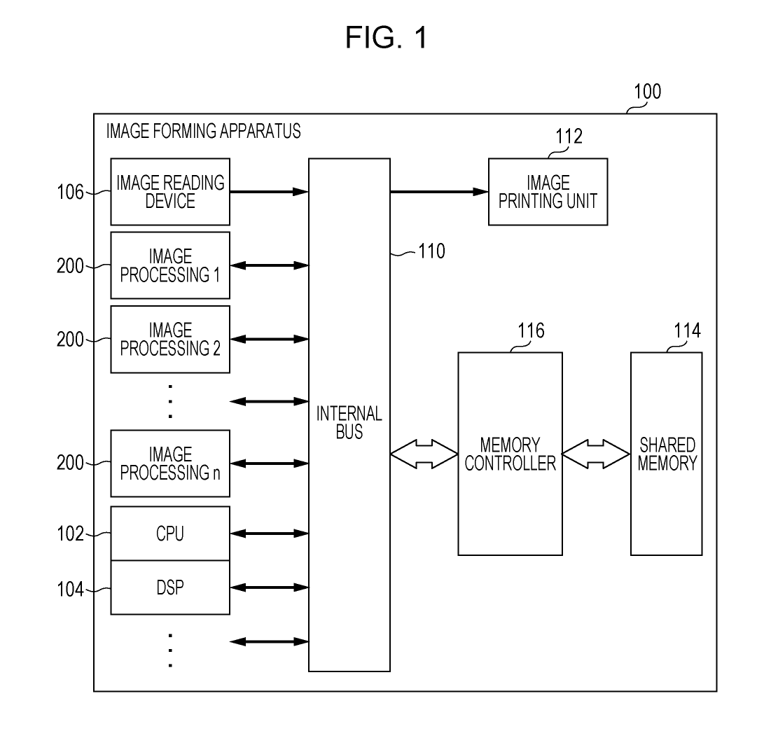

FIG. 1 illustrates an example of an information processing system of an image forming apparatus 100 to which a mechanism of the present exemplary embodiment is applied. The image forming apparatus 100 is an apparatus that performs one or more of operations such as image reading and output (printing, fax transmission). Examples of the image forming apparatus 100 include a printer, a scanner, a copier, a facsimile machine, and a multifunction apparatus integrating these functions.

This system includes a central processing unit (CPU) 102 connected to an internal bus 110, a digital signal processor (DSP) 104, an image reading device (scanner) 106, an image printing unit (printer) 112, and one or more image processing units 200 (denoted as “IMAGE PROCESSING n” (n is a number) in FIG. 1). Further, a shared memory 114 shared by the elements such as the CPU 102 is connected to the internal bus 110 via a memory controller 116.

The CPU 102 executes various programs such as a control program for controlling the operation of the image forming apparatus 100 and a program for image processing. When executing these programs, the CPU 102 uses the shared memory 114 as a work area. The DSP 104 performs digital signal processing on signals used in the image forming apparatus 100. The image reading device 106 reads the image of a document, for the functions such as scanning and copying, and generates image data representing the image. The image printing unit 112 prints image data on paper, for the functions such as printing and copying.

Each image processing unit 200 performs various types of image processing on image data handled by the image forming apparatus 100 (for example, an image read by the image reading device 106 and an image to be printed by the image printing unit 112). The image processing performed by the image processing unit 200 is not particularly limited.

The memory controller 116 processes a read request and a write request directed from the elements on the internal bus 110 to the shared memory 114.

The internal bus 110 is a transfer path for transferring data between the elements inside the integrated system such as the CPU 102. The internal bus 110 is a bus that maintains the order of read requests and the order of write requests, but does not ensure the order relationship between read requests and write requests, in view of the transfer efficiency and so on. The internal bus 110 is a bus that conforms to the AXI protocol. Accordingly, even in the case where a write request and a read request are issued in this order from the same image processing unit 200 to the memory controller 116, for example, if the time interval between the two requests is short, the order in which the two requests are received by the memory controller 116 may be inverted.

The internal bus 110 may be plural buses connected via a bus bridge. In the case where plural buses that do not ensure the order relationship between reads and writes are present on the path from the CPU 102, the image processing units 200, and so on to the memory controller 116, the order of a read request and a write request is more likely to be inverted.

In the present exemplary embodiment, the elements such as the CPU 102, the image processing units 200, and so on that issue read requests and write requests to the shared memory 114 are provided with a mechanism that prevents the order between read requests and write requests from being inverted. This mechanism will be described below, using the image processing unit 200 as an example.

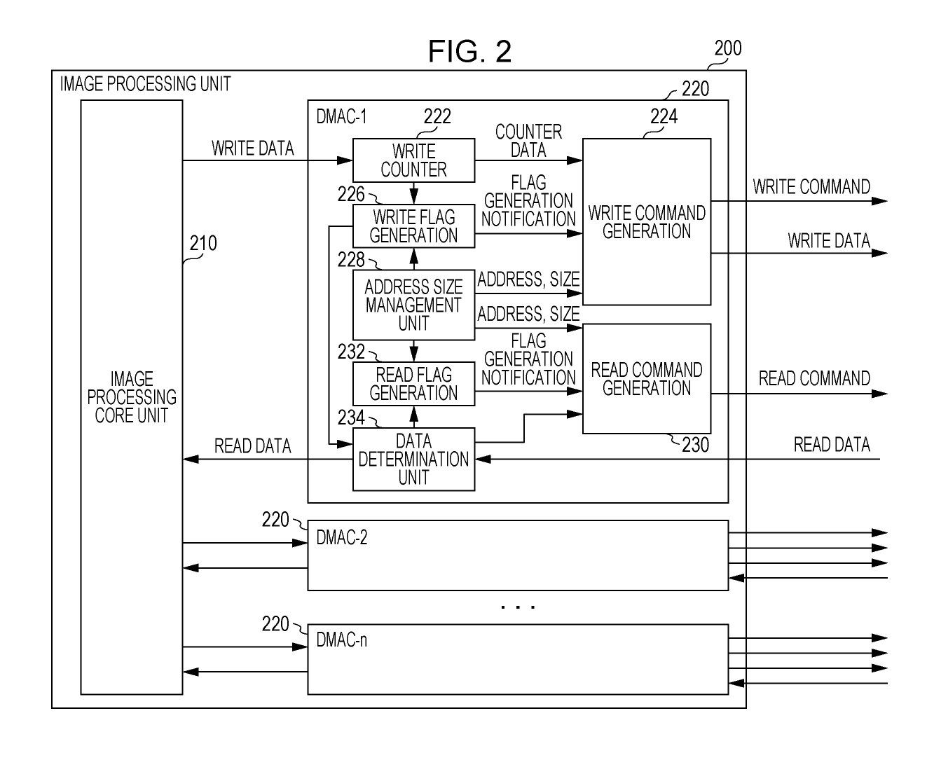

FIG. 2 illustrates an example of an internal configuration of the image processing unit 200 according to the present exemplary embodiment. In FIG. 2, the image processing unit 200 includes an image processing core unit 210, and one or more Direct Memory Access Controllers (DMACs) 220.

The image processing core unit 210 is an element that performs image processing for which the image processing unit 200 is responsible. The image processing core unit 210 may be configured as a hardware circuit, may be configured as software by causing a general-purpose processor to execute a program for image processing, or may be configured as a combination of a hardware circuit and processing by software. The image processing core unit 210 instructs the DMACs 220 to write data and read data.

Each DMAC 220 controls DMA transfer between the image processing unit 200 and other devices on the internal bus 110 (for example, the memory controller 116).

In the DMAC 220, a write counter 222 calculates the amount of write data (data to be written to the shared memory 114) that is input from the image processing core unit 210. Counter data indicating the calculation result is transmitted to a write command generation unit (denoted as “WRITE COMMAND GENERATION” in FIG. 2) 224 and a write flag generation unit (“WRITE FLAG GENERATION” in FIG. 2) 226. The write command generation unit 224 generates a write command (write request) for writing data to the shared memory 114.

The write flag generation unit 226 generates a flag for control according to the present exemplary embodiment. The flag is confirmation information used for confirming completion of writing write data of a specified (that is, predetermined) processing unit. The DMAC 220 issues a write command for writing a flag each time the DMAC 220 issues a write command for data of a processing unit. Since the internal bus 110 ensures the order relationship between write commands, if it is confirmed that a flag is written in the shared memory 114, this indicates that the data of the immediately preceding processing unit has been written in the shared memory 114. Utilizing this fact, in the present exemplary embodiment, control is performed such that after confirming that data of a processing unit is written in the shared memory 114, a read command (read request) for the processing unit is issued. This prevents a read command for a processing unit from overtaking a write command for the processing unit (as will be described in detail below).

The term “processing unit” as used herein refers to a range of an image that is treated as a unit of processing when the image processing unit 200 performs image processing using the shared memory 114. The processing unit may be, for example, a line of an image, a band (that is, a predetermined number of continuous lines), a page, or the like.

An address size management unit 228 generates the address of the write destination of a write command and the size of data to be written, and generates the address of the read destination of a read command and the size of data to be read. The address size management unit 228 transmits the generated information to the write command generation unit 224 and a read command generation unit 230.

The read command generation unit (denoted as “READ COMMAND GENERATION” in FIG. 2) 230 generates a read command (read request) for reading data from the shared memory 114.

A read flag generation unit (denoted as “READ FLAG GENERATION” in FIG. 2) 232 generates an instruction for reading a flag written in the shared memory 114. Upon receiving this instruction (flag generation notification), the read command generation unit 230 issues a read command for reading the flag written in the shared memory 114.

A data determination unit 234 determines whether data read from the shared memory 114 in response to the instruction from the read flag generation unit 232 matches a flag written to the shared memory 114 in response to the instruction from the write flag generation unit 226. If the data matches the flag, the flag has been written in the shared memory 114. This indicates that data of a processing unit corresponding to a write command issued before the flag has been written in the shared memory 114.

In one example, if the read data matches the written flag, the data determination unit 234 notifies the read command generation unit 230 of completion of writing the processing unit. The read command generation unit 230 does not issue a read command for a processing unit that is being written by the write command generation unit 224, and suspends issuance of the read command until a notification is received. Then, upon receiving the notification, the read command generation unit 230 starts issuance of the read command for the processing unit.

In another example, if the read data matches the written flag, the data determination unit 234 notifies the image processing core unit 210 of completion of writing the processing unit. In response to the notification, the image processing core unit 210 starts reading of the processing unit. In this example, the image processing core unit 210 does not start reading of the processing unit until writing of the processing unit is completed.

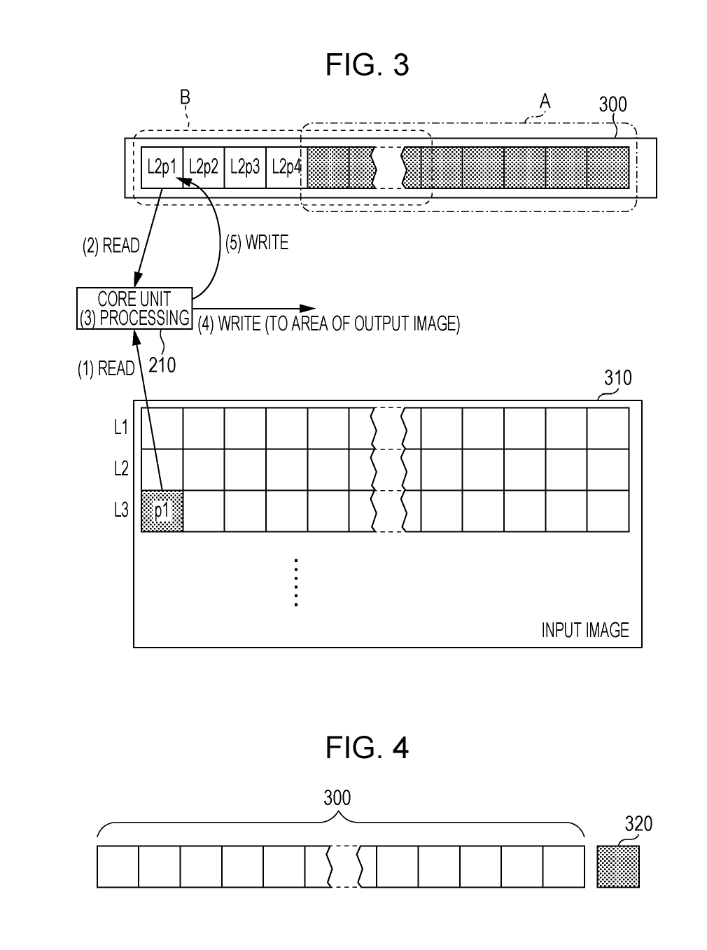

In the following, a problem that may occur when the image processing core unit 210 performs image processing using a line buffer 300 reserved in the shared memory 114 will be described with reference to FIG. 3.

In this example, the image processing core unit 210 processes an n-th pixel (n is a positive integer; denoted as pn in FIG. 3) of an m-th line (m is a positive integer; denoted as Lm in FIG. 3) of an input image 310 held in the shared memory 114 in combination with an image in the immediately preceding line (L(m−1)) held in the line buffer 300 (by taking the average of the current line and the immediately preceding line, for example). The operations performed by the image processing core unit 210 and the DMAC 220 in this case will be described below. The following describes a problem that occurs in the case where the DMAC 220 does not perform the above-described confirmation as to whether a processing unit is written using a flag. FIG. 3 schematically illustrates the condition when a first pixel p1 of a third line L3 of the input image 310 is processed.

The image processing core unit 210 repeats the following operations.

(1) Request the DMAC 220 for data of the n-th pixel of the m-th line of the input image 310 to obtain the data (or more accurately, request for data at the address of the n-th pixel in the shared memory 114 to obtain the data; the same applies to the following description).
(2) Request the DMAC 220 for data of an n-th pixel of the line buffer 300 (an (m−1)-th line) to obtain the data.
(3) Process the two pixels obtained in the above steps (1) and (2).
(4) Output the processing result of the above step (3) as an n-th pixel of an m-th line of the area (not illustrated) of an output image in the shared memory 114.
(5) Write the data read in the step (1) to the n-th pixel of the line buffer 300 (Overwrite the value of the n-th pixel of the line buffer 300 with the value of the corresponding pixel of the m-th line).
(6) If the pixel number n is the last pixel of the line, increment the line number m by 1. If not, increment the pixel number n by 1. Return to the step (1).

Upon receiving from the image processing core unit 210 a request for reading pixel data in the line buffer 300 (the step (2)), the DMAC 220 performs the following operations. Note that the DMAC 220 includes an internal buffer of a transfer size (hereinafter also referred to as a “transfer unit”; for example, the number of transfer cycles per 4 bytes×1 burst) of a single burst transfer of DMA, for each of reading and writing.

(7) Obtain from the image processing core unit 210 a read request for the n-th pixel (address) in the line buffer 300.
(8) If data of the pixel is present in the internal read buffer, return the data.
(9) If data of the pixel is not present in the internal read buffer, read data of the transfer size, starting with that pixel, from the line buffer 300 (a read command for DMA transfer), buffer the data in the internal buffer, and return the data of the pixel to the image processing core unit 210.

Similar operations are performed when the DMAC 220 receives from the image processing core unit 210 a request for reading pixels of an input image.

Upon receiving from the image processing core unit 210 a request for writing data to the n-th pixel in the line buffer 300 (the step (5)), the DMAC 220 performs the following operations.

(10) Obtain from the image processing core unit 210 a write request for data to the n-th pixel in the line buffer 300.
(11) Write the data to the corresponding pixel (address) in the internal write buffer.
(12) If the internal write buffer becomes full, or if the data of the last pixel of the line (which may be determined from the count of the write counter 222) is written to the internal buffer, write the data of the internal buffer to the line buffer 300 (a write command for DMA transfer), and clear the internal buffer.

Similar operations are performed when the DMAC 220 receives from the image processing core unit 210 a request for writing pixels of an output image.

In the example of FIG. 3, it is assumed that the image processing core unit 210 proceeds with processing of a second line, transmits to the DMAC 220 a write request for writing the last pixel of the second line to the line buffer 300, and subsequently transmits to the DMAC 220 a read request for reading a first pixel of the line buffer 300 (at this time point, the pixels of the second line are supposed to be held) to process a first pixel of a third line. In this case, as is understood from the description of the steps (12) and (9), when the DMAC 220 having received a write request for data of the last pixel of the second line writes the data to the internal write buffer, the DMAC 220 issues to the internal bus 110 a write command for writing a pixel group A in its internal buffer. Further, upon receiving a read command for the top pixel of the third line, the DMAC 220 issues to the internal bus 110 a read command for reading a pixel group B of a transfer unit starting with the first pixel. Accordingly, the time difference between issuance of the write command and issuance of the read command is very small, substantially corresponding to one pixel. Therefore, the read command is likely to overtake the write command in the internal bus 110.

If the data size of one line is small (for example, if the width of the image to be processed is small, or if the data amount of each pixel is small as in the case of a facsimile image), there is an overlap between the pixel group A that is written by the write command and the pixel group B that is read by the read command. In this case, if the read command overtakes the write command, the DMAC 220 reads the pixel group B from the line buffer 300 before the pixel group A of the line buffer 300 is written. In this case, as for a pixel overlapping the two pixel groups, the DMAC 220 reads the pixel value that is yet to be overwritten by the write command. This pixel value is an incorrect value different from the pixel value to be read, resulting in failing to obtain a correct processing result.

Further, if the internal bus 110 is one that is formed by connecting plural buses that do not ensure the order relationship between reads and writes, the order of write commands and read commands is more likely to be switched. For example, a read command for reading the top transfer unit of the third line may overtake not only a write command for the last transfer unit of the second line, but also the first and second preceding write commands thereof. Accordingly, the top read command for the third line is more likely to read an incorrect value that is yet to be overwritten by a write command.

As descried above, in the image processing using the line buffer 300, a read command for reading a pixel group including the top pixel of the line buffer 300 may read the pixel values that are yet to be overwritten by the preceding write command.

Meanwhile, in the present exemplary embodiment, the flag described above is used to prevent occurrence of this problem.

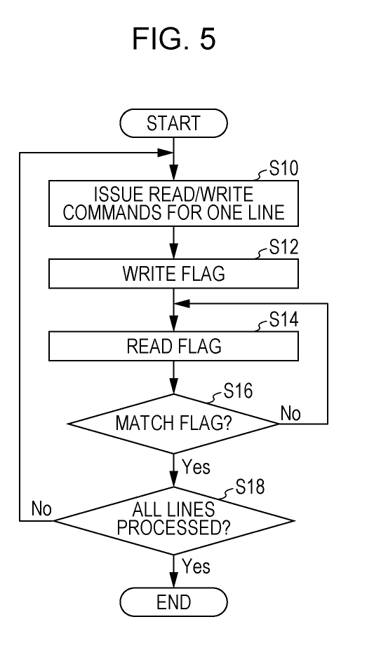

That is, in the present exemplary embodiment, as illustrated in FIG. 4, a flag area 320 is reserved at an address different from the line buffer 300 in the shared memory 114 (for example, the address immediately following the line buffer 300). Then, the DMAC 220 performs the process illustrated in FIG. 5.

According to the procedure of FIG. 5, the DMAC 220 repeats the steps S10 to S18 for each line of an image. Note that, before starting processing of an image, the data amount of each line and the number of lines of the image are reported from the image processing core unit 210 to the DMAC 220.

First, the read command generation unit 230 and the write command generation unit 224 of the DMAC 220 sequentially issue read commands and write commands for one line for the line buffer 300 to the internal bus 110, in response to a read command and a write command from the image processing core unit 210 (S10). Generally, each of a read command and a write command is issued plural times for processing one line.

Upon detecting completion of issuance of write commands for one line, the write counter 222 of the DMAC 220 instructs the write flag generation unit 226 to generate a flag. In response to this instruction, the write flag generation unit 226 generates a flag, and instructs the write command generation unit 224 to generate a write command for writing the flag to the flag area 320. In response to this, the write command generation unit 224 issues to the internal bus 110 a write command for writing the flag (S12).

Note that the write flag generation unit 226 generates, for each line, a flag having a value that is different from at least the value of a flag generated for the immediately preceding line. This is because, if the same flag as that used for the immediately preceding line is used, it is not possible to determine whether the flag written in the flag area 320 is the one for the immediately preceding line or the one for the current line. The write flag generation unit 226 generates, as a flag that satisfies such a condition, a flag including the number of the current line, for example. Using the line number as a flag allows to determine up to which line the processing is performed, by reading the value of the flag in the flag area 320, upon debugging or investigation of the cause of a failure of the image processing unit 200, for example.

Note that the value of a flag that is written for the current line does not have to be different from the value of a flag used for the immediately preceding line. For example, if a step is added in which the DMAC 220 clears (deletes data in) the flag area 320 after it is confirmed in S16 of FIG. 5 that the flag is written to the shared memory 114 (determination result: Yes), the flag that is written to the flag area 320 may have the same value every time. In this case, however, the step of clearing the flag area 320 adds extra processing time.

After S12, the read flag generation unit 232 instructs the read command generation unit 230 to read the flag area 320. In response to this, the read command generation unit 230 issues to the internal bus 110 a read command for reading the flag area 320 (S14).

Then, the data determination unit 234 determines whether the data returned from the shared memory 114 in response to the read command of S14 (data read from the flag area 320) matches the value of the flag written to the flag area 320 in S12 (S16). If the determination result is No, this indicates that the flag of S12 is not yet written to the flag area 320 (that is, the write command of S12 is overtaken by the read command of S14). Accordingly, the process returns to S14, in which the read command generation unit 230 issues again a read command for reading the flag area 320. The steps S14 and S16 are repeated until the determination result of S16 becomes Yes.

When the determination result of S16 becomes Yes, this indicates that writing to the line buffer 300 is completed up to the last pixel of the current line. In this case, the DMAC 220 determines whether processing is completed up to the last line of the image (S18). If the determination result is No, the process returns to S10 to process the next line. If the determination result of S18 is Yes, the process of FIG. 5 ends.

In the process of FIG. 5, even if a read command for the line buffer 300 for processing an (m+1)-th line is received from the image processing core unit 210, the DMAC 220 does not issue a read command in response to the request before confirming that a flag for the m-th line is written to the flag area 320 (S16). A read command for processing the (m+1)-th line is issued only after it is confirmed that the flag is written in S16.

Accordingly, the read command for the (m+1)-th line is prevented from overtaking the last write command for the m-th line.

It is common to perform a control operation that, when data is written to a memory, determines whether the data is correctly written to the memory by reading the data from the address of the write destination. However, in the case where this idea is applied to the image processing unit 200, if such a confirmation process is performed for all the pixels of a line, the processing speed is reduced. Thus, to reduce decrease in processing speed, the pixels used for confirming the writing may be limited to a predetermined number of last pixels of a line. However, this method does not work correctly. This is because the values of a predetermined number of last pixels may match the values of a predetermined number of last pixels of the immediately preceding line. Especially, in the case of a document image, a pixel group at the end of a line is often blank, that is, often has a value of 0. Therefore, even if the data read from the address of the end of the line of the line buffer 300 is the data of the immediately preceding line, the read data is likely to match the data of the end of the current line. Therefore, with the method of confirming by reading the data at the end of the line buffer 300, it is not possible to accurately determine whether the current line is written up to the end.

Meanwhile, in the present exemplary embodiment, the flag area 320 is provided outside the line buffer 300, and a flag different from image data is written thereto. Accordingly, in the case where the flag for the current line has a value different from the value of the flag for the immediately preceding line, when the flag for the current line is read, it is possible to confirm that the current line is written up to the end.

In the example described above, since the DMACs 220 in the image processing unit 200 performs control to prevent overtaking by a read command, the memory controller 116 and the shared memory 114 serving as its counterparties do not need to have a special configuration.

An exemplary case of image processing in units of lines using the line buffer 300 is described above. However, the same mechanism may be employed in the case of image processing in units of elements other than lines, such as in units of bands or pages.

Further, the example described above is one for maintaining the order between reads and writes in a single image processing unit 200. However, also in the case where different devices (the CPU 102, the respective image processing units 200, and so on) on the internal bus 110 perform processing in cooperation with each other, the order between reads and writes may be maintained using the same mechanism. The following describes the necessity of maintaining the order of reads and writes between different devices, and an exemplary embodiment therefor.

For example, assume a case where a first image processing unit 200 processes an image of a certain processing unit, and a different second image processing unit 200 processes an image resulting from the processing. In this case, a program for total control executed by the CPU 102 first instructs the first image processing unit 200 to process an input image. After completion of the processing, the program instructs the second image processing unit 200 to process the image resulting from the processing and written to the shared memory 114. According to conventional methods, upon issuing a write command for writing the last transfer unit of the processing result of the image of a processing unit to the shared memory 114, the first image processing unit 200 notifies the CPU 102 (control program) of completion of the processing. Then, the CPU 102 instructs the second image processing unit 200 to start processing of the processing result in the shared memory 114. In response to this, the second image processing unit 200 issues a read command for reading the processing result in the shared memory 114.

In this case, when the first image processing unit 200 notifies of completion of processing of the processing unit, it is not known whether the last portion of the data of the processing result of the processing unit is written to the shared memory 114. The second image processing unit 200, triggered by the processing completion notification, reads the processing result in the shared memory 114. Therefore, if the order of a read command and a write command is switched in the internal bus 110, the second image processing unit 200 may read the address of the processing result in the shared memory 114, before completion of writing the processing result of the first image processing unit 200. In this case, the read data includes incorrect data, so that the processing by the second image processing unit 200 is not correctly performed.

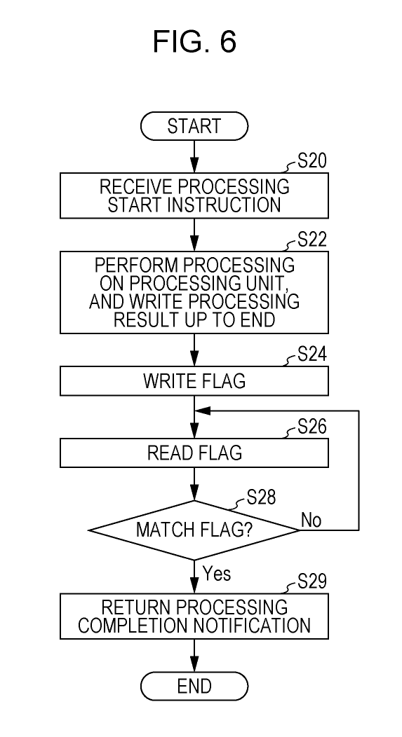

A control operation using a flag similar to that of the example described above may be used as a method for addressing this problem. FIG. 6 illustrates the processing procedure of the image processing unit 200 according to this modification.

According to the procedure of FIG. 6, the image processing unit 200 first receives a processing start instruction for a certain processing unit from the CPU 102 (S20). This instruction includes, for example, information on the address and size of input data of the processing unit stored in the shared memory 114, and information on the address and size of an output area to which data of the processing result is to be written.

Then, the image processing unit 200 causes the DMAC 220 to read the input data of the processing unit from the shared memory 114, process the input data, and write the data of the processing result to the output area of the shared memory 114 (S22). After issuing a write command for writing the last portion of the data of the processing result, the DMAC 220 issues a write command for writing a flag for confirmation of completion of writing to a predetermined flag area different from both the area of the input data and the output area in the shared memory 114 (S24).

After issuing the write command for a flag in S24, the DMAC 220 issues a read command for reading the flag area (S26). Then, the DMAC 220 determines whether data returned from the shared memory 114 in response to the read command matches the flag written in S24 (S28). If the data does not match the flag, the DMAC 220 repeats reading of the flag area (S26) and determination (S28) again. When the determination result of S28 becomes Yes, the image processing unit 200 transmits a notification of completion of processing to the CPU 102 (S29). Upon receiving the notification of completion of processing, the CPU 102 instructs another image processing unit 200 that subsequently performs processing using the data of the processing result in the shared memory 114 to start processing.

In this modification, identification information of a processing unit (for example, the page number if the processing unit is a page; and the band number if the processing unit is a band) may be used as a flag that is written to the flag area by the DMAC 220 after the processing unit. Using the number of the processing unit as a flag allows to determine up to which processing unit the processing is performed, by reading the value of the flag in the flag area 320, upon debugging or investigation of the cause of a failure of the image processing unit 200, for example.

Further, a combination of identification information of the image processing unit 200 and identification information of the processing unit may be used as a flag. This allows to determine by which image processing unit 200 and up to which processing unit the processing is performed, by reading the value of the flag in the flag area 320, upon debugging or investigation of the cause of a failure of the image processing unit 200, for example.

Although FIG. 6 illustrates the processing procedure of the image processing unit 200, the CPU 102 or the DSP 104 may perform similar processing. For example, assume a case where that a certain image processing unit 200 uses, for image processing, data generated by execution of a program by the CPU 102. This may be the case where, for example, the CPU 102 generates a sequence of coordinates of the top addresses of the respective lines of an image to be processed by the image processing unit 200, and the image processing unit 200 specifies the respective lines of the image data in the shared memory 114 by referring to the sequence, and performs processing. In such a case, similar to the procedure of FIG. 6, the CPU 102 (program) or the DMAC 220 accompanying therewith issues to the internal bus 110 a write command for writing the last portion of the data to the shared memory 114 (S22), and then issues a write command for writing a flag to the flag area (S24). After that, the CPU 102 or the like reads the flag area. If the flag written in S24 is read (Yes in S28), the CPU 102 or the like instructs the image processing unit 200 to start processing using the data.

In the example of FIG. 6, the CPU 102 (control program) receives a processing completion notification from the image processing unit 200, and instructs another image processing unit 200 that subsequently performs processing to start processing. Another example for this is a method that causes a certain image processing unit 200 and another image processing unit 200 that performs processing using the processing result of the certain image processing unit 200 to cooperate without intervention of the CPU 102 (control program). The following describes a modification of this method.

According to this modification, when starting cooperative processing in which plural image processing units 200 cooperate with each other, the CPU 102 instructs the plural image processing units 200 to start processing. In this case, the CPU 102 transmits, to the image processing unit 200 that needs to perform processing using the processing result of the preceding image processing unit 200 in the cooperative processing, information (address, size, and so on) on each of the areas in the shared memory 114 to which the processing result and a flag are to be respectively written, and flag value information specifying the value of a flag to be written to the flag area (for example, a rule that determines the value of a flag for each processing unit), in association with the instruction for starting processing. The image processing unit 200 having received the instruction for starting processing periodically reads the flag area, for example, and starts processing using the processing result of the preceding image processing unit 200 if the value specified by the flag value information is read.

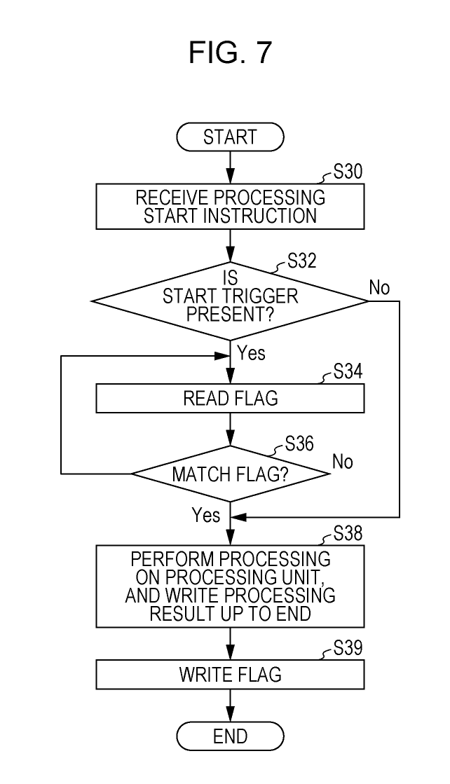

FIG. 7 illustrates the processing procedure of the image processing unit 200 according to the modification. This procedure starts when the image processing unit 200 receives an instruction for staring processing from the CPU 102 (control program) (S30).

The instruction includes, for each of the following items, information indicating the storage area (address, size, and so on) in the shared memory 114: (a) input data to be processed by the image processing unit 200; (b) a start flag that triggers the start of the processing (not needed if the processing is the first processing of the cooperative processing); (c) output data as the result of the processing; and (d) a completion flag indicating completion of writing the output data (not needed if the processing is the last processing of the cooperative processing). Output data and a completion flag of a certain image processing unit 200 serve as input data and a start flag of the next image processing unit 200 in cooperative processing.

The processing start instruction may include start flag value information specifying the value of a start flag. The start flag value information is information specifying the value of a start flag that should have been written by the preceding image processing unit 200 to the area for a start flag to be read by the current image processing unit 200. This information may be the value of a start flag, or may be information indicating a rule that determines the value of a start flag. Examples of the rule include a rule indicating that, for example, the number of the processing unit is used as a start flag, and a rule indicating that a combination of identification information of the image processing unit 200 by which the processing result (output data) for the processing unit is generated and the number of the processing unit is used as a start flag. Note that in the case where start flag value information is set in advance in the image processing unit 200, the CPU 102 does not have to issue an instruction.

The processing start instruction may include end flag value information specifying the value of an end flag. The end flag value information is information specifying the value of an end flag to be written to the shared memory 114 by the image processing unit 200 after the processing result. End flag value information provided to a certain image processing unit 200 and start flag value information provided to another image processing unit 200 that performs processing using the processing result of the certain image processing unit 200 in the cooperative processing correspond to each other. Note that in the case where end flag value information is set in advance in the image processing unit 200, the CPU 102 does not have to issue an instruction.

After S30, the image processing unit 200 determines whether the instruction from the CPU 102 includes information on the area of the start flag (S32). If the determination result is Yes, the image processing unit 200 issues a read command for the start flag area (S34), and determines whether the value read from the shared memory 114 in response to this read command matches the start flag specified by the start flag value information (S36). If the value does not match the start flag, the image processing unit 200 repeats reading the start flag area (S34). If the value matches the start flag, the image processing unit 200 performs its processing by reading input data from the shared memory 114, and writes the result of the processing to the specified area for output data (S38). Then, after completion of writing (issuance of a write command) of the last portion of the processing result, the image processing unit 200 writes a completion flag specified by completion flag value information to the specified completion flag area (S39).

Note that in the case where the image processing unit 200 processes plural processing units in response to a single processing start instruction, the image processing unit 200 may repeat the operations of S32 to S39 for each processing unit. In this case, a start flag and an end flag for a certain processing unit may have values different from those of a start flag and an end flag for the immediately preceding processing unit (for example, the flags may include the number of the processing unit).

The foregoing description of the exemplary embodiment of the present invention has been provided for the purposes of illustration and description. It is not intended to be exhaustive or to limit the invention to the precise forms disclosed. Obviously, many modifications and variations will be apparent to practitioners skilled in the art. The embodiment was chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A transfer control device comprising:
a write issuing unit that, after issuing to a transfer path a first write request for writing a last portion of data of a processing unit to a memory, issues a second write request for writing confirmation information to an area different from an area of the memory to which the data is written, the transfer path maintaining an order of write requests and an order of read requests and not maintaining an order between the write requests and the read requests; and
a read issuing unit that issues to the transfer path a first read request for reading the confirmation information, after the second write request is issued, and issues to the transfer path a second read request for the data of the processing unit written to the memory, after reading the confirmation information in response to the first read request.

2. The transfer control device according to claim 1, wherein the write issuing unit uses, as the confirmation information for the processing unit, information indicating a value different from a value indicated in confirmation information for an immediately preceding processing unit thereof.

3. The transfer control device according to claim 1, wherein the write issuing unit uses identification information of the processing unit as the confirmation information for the processing unit.

4. A processing device comprising:
a write issuing unit that, after issuing to a transfer path a first write request for writing a last portion of data to a memory, issues a second write request for writing confirmation information to an area different from an area of the memory to which the data is written, the transfer path maintaining an order of write requests and an order of read requests and not maintaining an order between the write requests and the read requests; and
a transmitting unit that issues to the transfer path a read request for reading the confirmation information, after the second write request is issued, and transmits to a control device a completion notification indicating completion of writing the data to the memory when the confirmation information is read in response to the read request.

5. A processing system comprising:
a first processing device; and
a second processing device that performs processing using data written to a memory by the first processing device;
wherein the first processing device includes
a write issuing unit that, after issuing to a transfer path a first write request for writing a last portion of the data to a memory, issues a second write request for writing confirmation information to an area different from an area of the memory to which the data is written, the transfer path maintaining an order of write requests and an order of read requests and not maintaining an order between the write requests and the read requests; and
wherein the second processing device includes
a unit that issues to the transfer path a read request for reading the confirmation information in the memory, and
a unit that starts the processing using the data in the memory when the confirmation information is read in response to the read request.
